(19) United States
(12) Patent Application Publication
(10) Pub. No.: US 2003/0203078 A1
(43) Pub. Date: Oct. 30, 2003

(54) Candy magnifier

(76) Inventor: Ethan Summers, Charlotte, NC (US)

Correspondence Address: SCHWARTZ LAW FIRM, P.C., 6100 FAIRVIEW ROAD, SUITE 530, CHARLOTTE, NC, 28210, US

(21) Appl. No.: 10/448,872

(22) Filed: May 30, 2003

Related U.S. Application Data
(63) Continuation of application No. 09/992,237, filed on Nov. 6, 2001, now abandoned.

(51) Int. Cl. A23G 1/00

(52) U.S. Cl. 426/104

(57) ABSTRACT

A candy magnifier includes a convex magnifying lens formed of a crystallized flavored mixture. The magnifying lens is edible, and functions to enlarge the appearance of an object viewed through the lens.

### TECHNICAL FIELD AND BACKGROUND OF INVENTION

This application relates to a candy magnifier especially adapted for use and enjoyment by children. The invention includes an edible, flavored hard-candy magnifying lens which functions like a conventional glass or plastic magnifier to enlarge the appearance of objects viewed through the lens. The invention is relatively inexpensive to manufacture and has a substantial shelf life.

### SUMMARY OF INVENTION

Therefore, it is an object of the invention to provide candy magnifier which is edible.

It is another object of the invention to provide a candy magnifier which functions like a conventional glass or plastic magnifier.

It is another object of the invention to provide a candy magnifier which is relatively inexpensive to manufacture.

It is another object of the invention to provide a candy magnifier which has a substantial shelf life.

It is another object of the invention to provide a candy magnifier which is intended for entertaining children.

It is another object of the invention to provide a candy magnifier which has parts that are sufficiently large to avoid accidental swallowing or choking.

It is another object of the invention to provide a candy magnifier which is substantially sugar-free.

These and other objects of the present invention are achieved in the preferred embodiments disclosed below by providing a candy magnifier including a convex magnifying lens formed of a crystallized flavored mixture. The candy magnifier is adapted for enlarging the appearance of an object viewed through the lens.

According to another preferred embodiment of the invention, an elongated handle depends from the magnifying lens.

According to another preferred embodiment of the invention, the handle is formed entirely or partially of chewing gum.

According to another preferred embodiment of the invention, the handle has a threaded end.

According to another preferred embodiment of the invention, a complementary-threaded cap is applied to the threaded end of the handle to removably join the magnifying lens and the handle together.

According to another preferred embodiment of the invention, the cap includes a mounting paddle adapted for carrying the magnifying lens.

According to another preferred embodiment of the invention, the magnifying lens includes a base defining a paddle-receiving slot for receiving the mounting paddle of the cap.

According to another preferred embodiment of the invention, the magnifying lens has an integrally-formed annular frame.

According to another preferred embodiment of the invention, the crystallized flavored mixture includes corn syrup.

According to another preferred embodiment of the invention, the crystallized flavored mixture includes artificial fruit flavoring.

According to another preferred embodiment of the invention, the crystallized flavored mixture is substantially sugar-free.

The term “substantially sugar-free” means that the sugar content of the flavored mixture is less than 10 percent by volume of the overall composition.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a front elevational view of a candy magnifier according to one preferred embodiment of the invention;

FIG. 2 is a side perspective view of the candy magnifier;

FIG. 3 is an exploded view of the candy magnifier; and

FIG. 4 is an environmental view of the candy magnifier in the hand of a user.

### DESCRIPTION OF THE PREFERRED EMBODIMENT AND BEST MODE

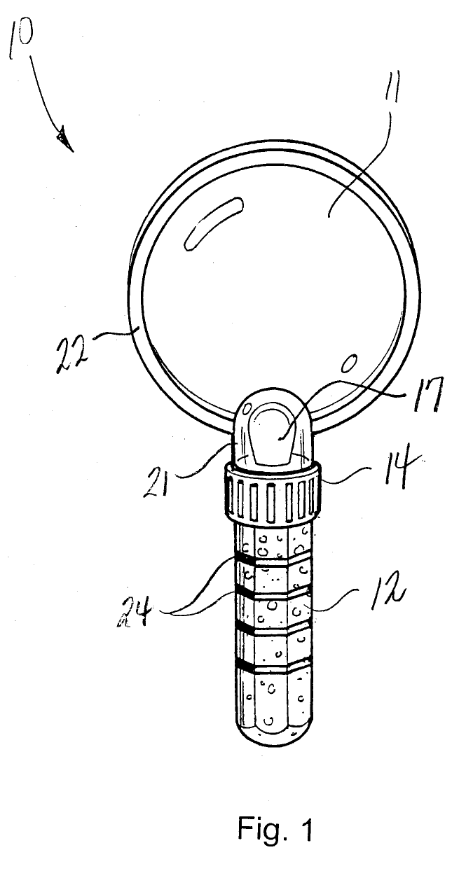

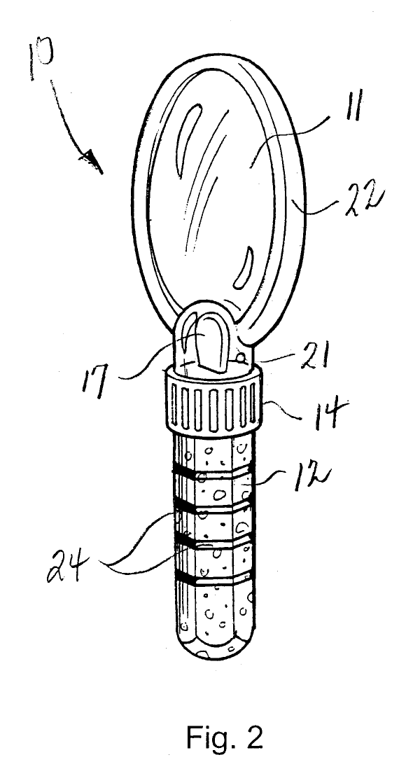

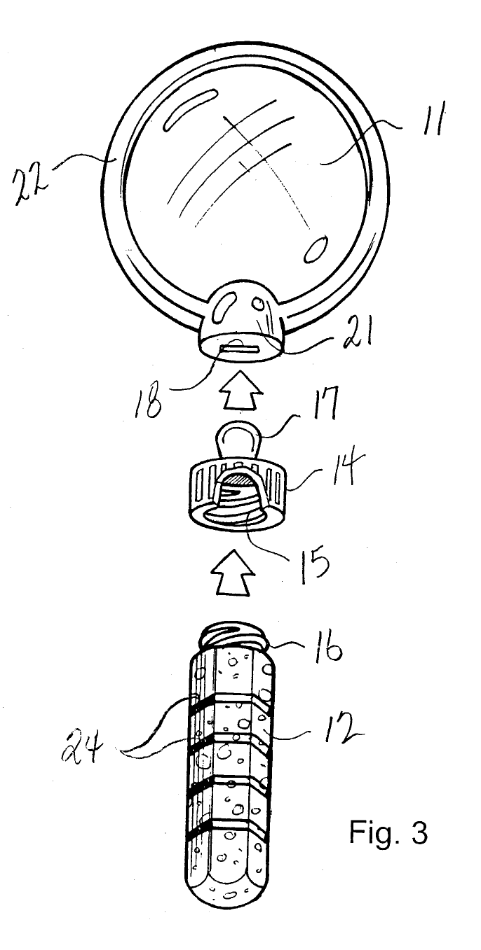

Referring now specifically to the drawings, a flavored candy magnifier according to the present invention is illustrated in FIGS. 1 and 2, and shown generally at reference numeral 10. The candy magnifier 10 includes an edible magnifying lens 11 and handle 12 joined together by a removable plastic mounting cap 14. As shown in FIG. 3, the mounting cap 14 has an internal screw thread 15 which mates with a complementary external thread 16 formed with a proximal end of the handle 12, and an outwardly projecting mounting paddle 17. The mounting paddle 17 is received within a slot 18 formed with a base 21 of the magnifying lens 11 to join the magnifying lens 11 and handle 12 together. The plastic cap 14 is preferably sufficiently large to meet child safety guidelines designed to avoid accidental swallowing or choking.

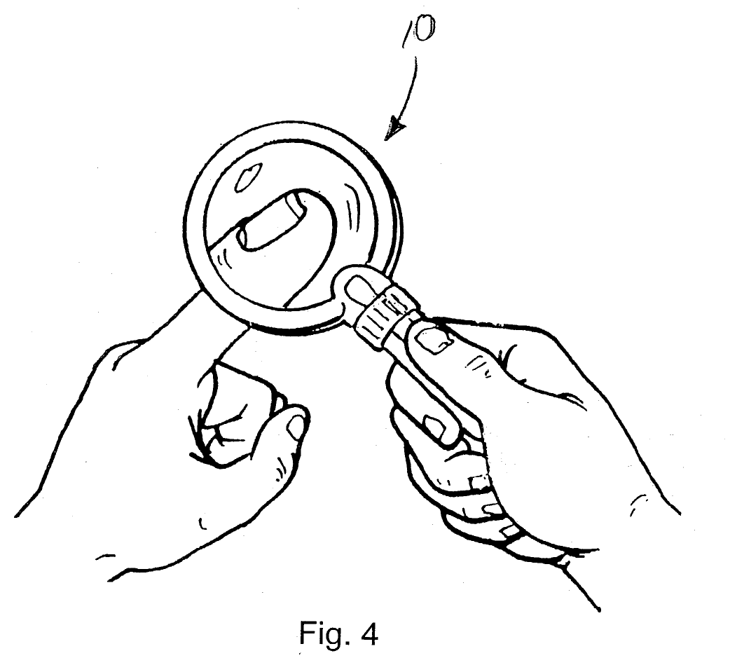

According to one embodiment, the magnifying lens 11 is formed of an edible crystallized mixture including sugar or artificial sweetener, corn syrup, water, and colorless fruit flavoring. In an alternative embodiment, the mixture is essentially sugar-free. The mixture is heated and poured into a concave mold where it hardens to form a substantially clear, convex lens with an integrally-formed annular frame 22. As shown in FIG. 4, the resulting candy magnifying lens 11 functions like a conventional glass or plastic magnifier to enlarge the appearance of objects viewed through the lens. As generally understood in the art, the magnifying lens 11 makes the rays from a viewed object converge as they enter the eye. Since the part of the brain that deals with vision always assumes that light rays arrive at the eye in straight lines, the brain perceives the viewed object as being larger than it really is. The annular frame 22 is preferably thicker than the lens 11, as shown in the drawings, the thickness being measured from one major surface of the lens to the other and from one side of the frame to the other.

The handle 12 of the candy magnifier 10 depends from the magnifying lens 11 and is likewise formed of a hard edible mixture. Preferably, the handle 12 is made of compressed sour powder candy and fruit-flavored bubble gum. Spaced annular grooves 24 are formed along the length of the handle 12 to provide respective weakness points allowing sections of the handle 12 to be broken off and chewed.

A candy magnifier is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A candy magnifier comprising:
(a) an elongated handle;
(b) a hardened, crystallized, flavored magnifying lens mounted at one end of said handle and adapted for enlarging the appearance of an object viewed through said lens; and
(c) a hardened, crystallized, flavored, annular frame integrally formed with said magnifying lens.

2. A candy magnifier according to claim 1, wherein said annular frame is thicker than said magnifying lens.

3. A candy magnifier according to claim 1, wherein said handle comprises chewing gum.

4. A candy magnifier according to claim 1, wherein said handle comprises a threaded end.

5. A candy magnifier according to claim 4, and comprising a complementary-threaded cap for being applied to the threaded end of said handle to removably join said magnifying lens and said handle together.

6. A candy magnifier according to claim 5, wherein said cap comprises a mounting paddle adapted for carrying said magnifying lens.

7. A candy magnifier according to claim 6, wherein said magnifying lens comprises a base defining a paddle-receiving slot for receiving the mounting paddle of said cap.

8. A candy magnifier according to claim 1, wherein said crystallized flavored mixture comprises corn syrup.

9. A candy magnifier according to claim 1, wherein said crystallized flavored mixture comprises artificial fruit flavoring.

10. A candy magnifier according to claim 1, wherein said crystallized flavored mixture is substantially sugar-free.
